(19) United States
(12) Patent Application Publication
(10) Pub. No.: US 2008/0235213 A1
(43) Pub. Date: Sep. 25, 2008

(54) Utilization of copyright media in second generation web content

(75) Inventor: Eyal Gura, Haifa (IL)

Correspondence Address: Martin D. Moynihan;PRTSI, Inc., P.O. Box 16446, Arlington, VA, 22215, US

(73) Assignee: PicScout (Israel) Ltd., Herzlia Pituach (IL)

(21) Appl. No.: 12/003,757

(22) Filed: Dec. 31, 2007

Related U.S. Application Data
(60) Provisional application No. 60/918,912, filed on Mar. 20, 2007.

(51) Int. Cl. G06F 17/30

(52) U.S. Cl. 707/5

(57) ABSTRACT

Content provision apparatus for suggesting media content from a media database to augment new textual content being published as a blog or the like, comprises: a text retrieval unit for retrieving new textual content over a network; a text analysis unit for analyzing the retrieved textual content; a search unit for using the analyzing of the retrieved textual content to search the media database to find media content suitable for the new textual content; and a dispatch unit for dispatching to an author of the text retrieval unit a suggestion for augmenting the new textual content. The suggestion is typically in the form of an email but alternatively may be sent using an RSS feed or via a comment for the blog. Preferably the media content can be pasted straight into the blog. A feature allows the content to carry advertising as a pop up label or link, and the advertising fee pays for the media usage rights.

### RELATED APPLICATION

This application claims the benefit of priority from U.S. Provisional Patent Application No. 60/918,912 filed Mar. 20, 2007, the contents of which are incorporated herein by reference.

### FIELD AND BACKGROUND OF THE INVENTION

The present invention relates to utilization of copyright or other media in second generation web content, the so-called Web 2.0, and, more particularly, but not exclusively to a system and method for making media items available for incorporation into blogs and like user-created content.

The original Word Wide Web, or Web 1.0 followed the paradigm of the web as an information source. Web 2.0 is a term used to describe a change in the web paradigm into a collaborative effort, the web as a participation architecture that encourages users to add their own content. Web 2.0 takes advantage of network effects and the participation of users to add value to itself. Key features of Web 2.0 are RSS feeds, blogs, wikis such as wikipedia, and websites that derive their content and functionality through user participation, such as Ebay, YOUTube etc.

A blogger is a modern form of a publisher, and the number of bloggers is currently estimated at around sixty million and growing. Bloggers need content but have difficulties in obtaining licenses. As the blogger is not a real media company, the blogger is not really in a position to obtain and pay for usage licenses for the media he wishes to use, and bloggers are not generally the primary owners of the web sites on which their blogs appear, so that enforcement is difficult and piracy is rife.

An issue with wider user participation is the question of usage rights to content. If one has a clearly identified web site provider it is possible to check whether he is using one's content and then one can complain if necessary. If however a site is put together by large numbers of relatively anonymous participants then it is much harder to make any impact.

Part of the problem is that Web 2.0 is a phenomenon that may be termed a public good. A public good characteristically has two properties: jointness of supply and non-excludability. The impossibility of excluding group-members who do not contribute to the provision of goods from sharing profits gives rise to the possibility that rational members will prefer to withhold their contribution of effort and will prefer to obtain a free-ride on the contribution of others.

Due to the difficulty in rights management there is thus a problem inducing media content owners to make their content available for use in Web 2.0. In particular artists, film makers, animators and photographers and stock libraries such as Gettyimages and Corbis may have images etc which could be used by Web 2.0 users, and which they would very much like to make available to a wider audience, but until the rights management issue is solved it is not wise for them to do so.

There is thus a widely recognized need for, and it would be highly advantageous to have, a system in which an inducement is provided but without at the same time destroying the spontaneity which is such an important characteristic of Web 2.0. More particularly, on the one hand there is a need for high-end content, but on the other hand there needs to be an easy way to license without requiring individual bloggers to pay license fees every time. At the present time there are estimated to be 1.6 million new blog posts every day, and sometimes the same blogger may post one or two blog posts per day.

### SUMMARY OF THE INVENTION

According to one aspect of the present invention there is provided content provision apparatus for suggesting media content from a media database to augment new textual content, the apparatus comprising:

a text retrieval unit configured for retrieving new textual content over a network;

a text analysis unit associated with the text retrieval unit, configured for analyzing the retrieved textual content;

a search unit configured for using the analyzing of the retrieved textual content to search the media database to find media content suitable for said new textual content; and

a dispatch unit configured for dispatching to an author of said text retrieval unit a suggestion for augmenting said new textual content, said suggestion comprising said suitable media content. In an embodiment the media has been selected by an organization to carry an advertising message or link, and an advertising fee is used to pay the media content rights holder for usage of the content.

According to a second aspect of the present invention there is provided a content provision method for suggesting media content from a media database to augment new textual content, the method comprising:

retrieving new textual content over a network;

analyzing the retrieved textual content;

using the analyzing of the retrieved textual content to search the media database to find media content suitable for said new textual content; and

dispatching to an author of said text retrieval unit a suggestion for augmenting said new textual content, said suggestion comprising said suitable media content.

It is noted that the media content is any kind of non-textual content, including music, video, animation, motion pictures, images of drawings, paintings and other artwork, and photographs.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic diagram illustrating a system for augmenting blogs and like authored text with media from a media catalog according to a first preferred embodiment of the present invention;

FIG. 2 is a simplified schematic diagram illustrating the system of FIG. 1 using a first alternative for retrieving newly authored text;

FIG. 3A is a simplified schematic diagram illustrating the system of FIG. 1 using a second alternative for retrieving newly authored text;

FIG. 3B is a simplified schematic diagram illustrating an email that may be used to dispatch the suggestions to the blog author;

FIG. 4 is a simplified schematic diagram illustrating a web log page into which suggestions suggested by the context have been inserted, according to a preferred embodiment of the present invention;

FIG. 5 is a simplified schematic diagram illustrating the web log page of FIG. 4 in which an inserted image has an embedded link and popup to an advertising site, therethrough to generate payments from advertising for digital rights management purposes;

FIG. 6 is a simplified diagram illustrating apparatus for providing distribution of media to web log authors according to a preferred embodiment of the present invention;

FIG. 7 is a simplified flow chart illustrating operation of the apparatus of FIG. 6 according to a preferred embodiment of the present invention;

FIG. 8 is a simplified flow chart illustrating a procedure for an advertiser to use the media database to support an advertising campaign according to a preferred embodiment of the present invention;

FIG. 9 is a simplified block diagram of an apparatus for supporting differential media database access by advertisers and blog authors, according to a preferred embodiment of the present invention; and

FIG. 10 is a block diagram of a network server configuration for supporting digital rights management of copyright images according to a preferred embodiment of the present invention.

### DESCRIPTION OF THE PREFERRED EMBODIMENTS

The present embodiments comprise an apparatus and a method for making media such as image and video content available freely to Web 2.0 authors and bloggers. Preferably the content is made available in a spontaneous or natural manner and data rights issues are managed.

Images or like content are preferably kept in a catalog and made available to the author in a spontaneous manner. In one embodiment the text written by the author is automatically analyzed to provide a semantic understanding. The semantic understanding is compared with key words of the image catalog to select an image and then the image selected is forwarded to the author as a suggestion. If the author likes the suggestion then he pastes the proffered image into his authored material.

Digital Rights issues may be dealt with in a number of ways. The most obvious way is for the author to pay a copyright fee for the media, but a preferred embodiment involves embedding a link within the proffered content to a commercial site. The owner of the commercial site, who is advertising his products, pays an advertising fee and the advertising fee is provided as the copyright fee to the image provider. Alternatively, the fee may go to the publisher with a deduction for the copyright holder and also possibly for the manager of the catalog and DRM systems.

Finally, the image appears in association with the authored content. If a reader moves a cursor over the image he may be shown a reference to the commercial site. Subsequently if he clicks on the image or the displayed reference he may be taken to the commercial site.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

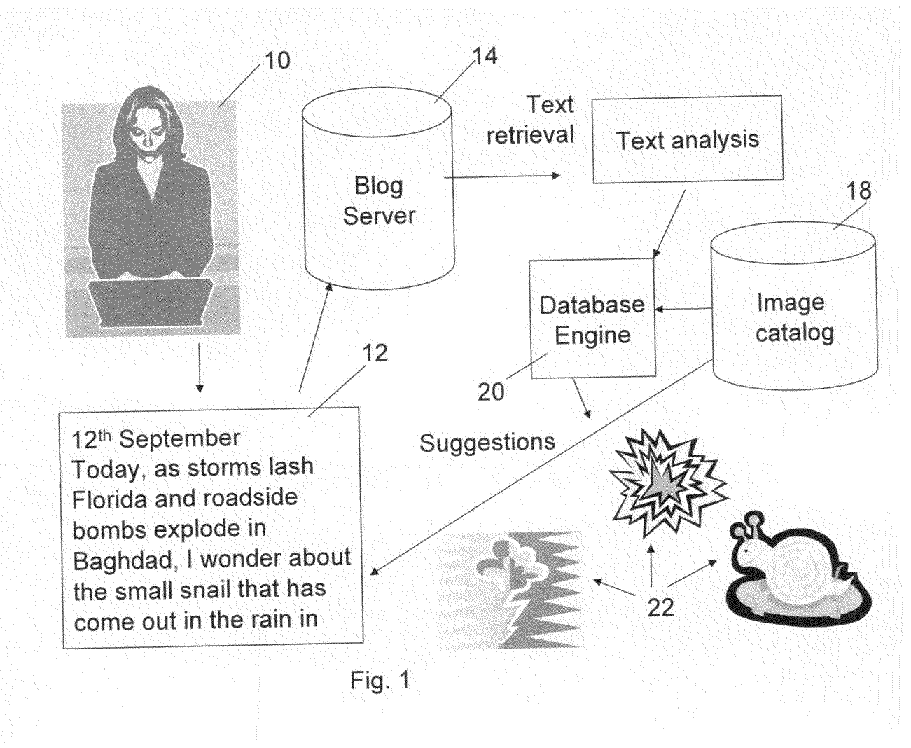

Reference is now made to FIG. 1, which is a schematic diagram that shows a Web 2.0 author 10 writing a blog 12. The blog 12 becomes part of a Web 2.0 website located on blog server 14.

Newly inserted text from the author is submitted to a text analysis engine 16 which may be located at blog server 14 or more usually remotely therefrom. The text analysis engine may identify themes or keywords from the blog text and then the identified themes are matched against keywords of image catalog 18. The matching process is managed by database engine 20 which then packages suggestions 22 into emails which are sent to the author 10. The author 10 may then insert the suggestions into her text as desired.

As an alternative to emails, the blog platform may have its own infrastructure for general blogging feedback. Such infrastructure may be used to supply the image suggestions. As a further alternative an RSS (Really simple syndication) feed to the blog publisher may be used to supply the suggestions.

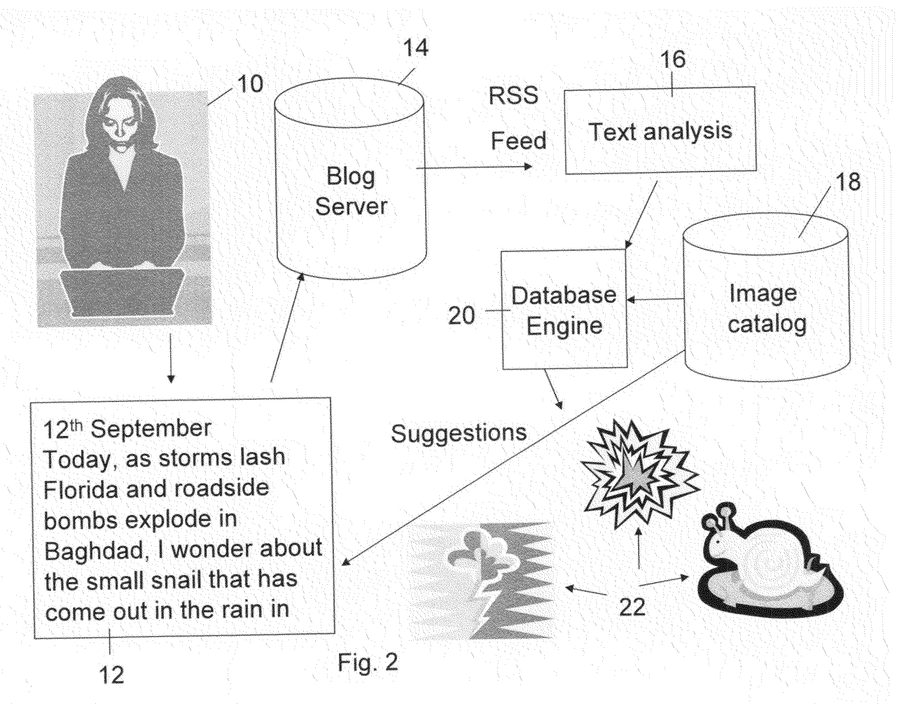

Reference is now made to FIG. 2, which is the same schematic diagram as in FIG. 1 and additionally showing a first possibility for providing newly authored text to the text analysis engine in the case that the text analysis engine is located remotely from the blog server 14.

In the case of FIG. 2, the blog server 14 uses an RSS feed—really simple syndication—to inform the text analysis engine of any newly entered blog text. RSS is a web feed format based on XML and is typically used to publish material to multiple sites across the Internet. Typically the feed user supplies his RSS reader with a link to the feed source, and the reader is then able to check the user's subscribed feeds to see if any of those feeds have new content since the last time it checked. If so, the reader retrieves the content and presents it to the user. The embodiment of FIG. 2 uses an RSS feed to provide new blog entries to the text analysis engine.

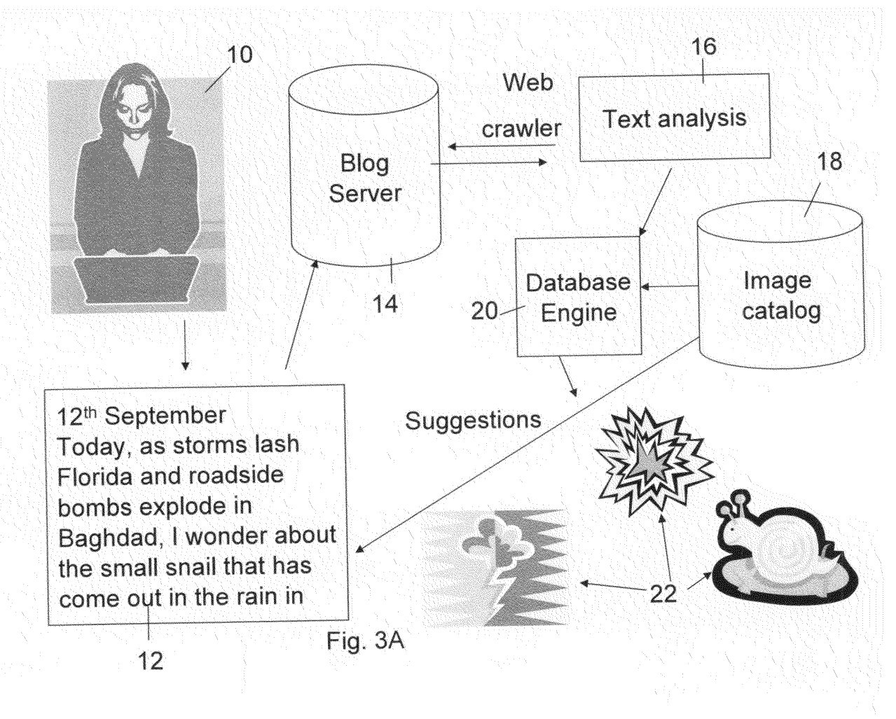

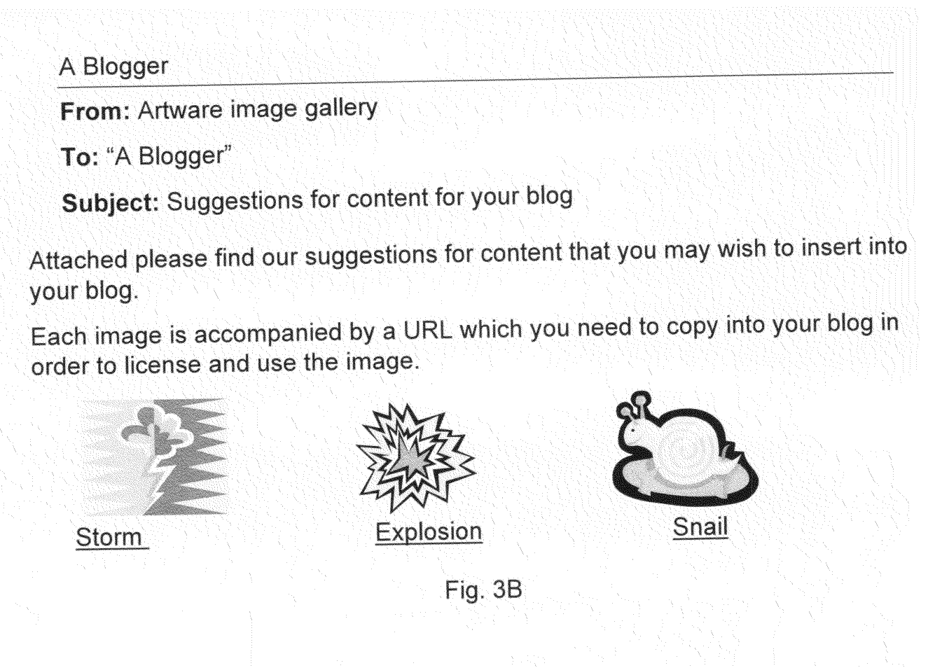

Reference is now made to FIG. 3A which is the same schematic diagram as in FIGS. 1 and 2, but this time illustrating an alternative embodiment for feeding the newly authored blog text 12 to the text analysis unit 16. In the case of FIG. 3 a web crawler is sent to blog server 14 to find the new text 12 and send it to the text analysis unit 16. A web crawler is a script or program which trawls the Internet in a methodical manner to discover content. Web crawlers are commonly used by search engines to create search indexes. In the present case the web crawlers preferably look specifically for blog content on identified servers. Alternatively the web crawlers may be sent to find any blog content that they can.

The text analysis may be provided as a user selectable option in the blog infrastructures or platform. If the feature is selected, then when the blogger finishes writing his text and selects posting,—he is given recommendations of images. As a further alternative the user may be shown a button that allows him to request suggestions of images.

FIG. 3B illustrates an email that may be used in sending the suggestions of FIG. 3A to the blog author. The suggested images or other media items are included together with URLs. The image and associated URLs are preferably copied from the email into the blog, and the URL then ensures that the advertising link is present in the image, as will be explained below.

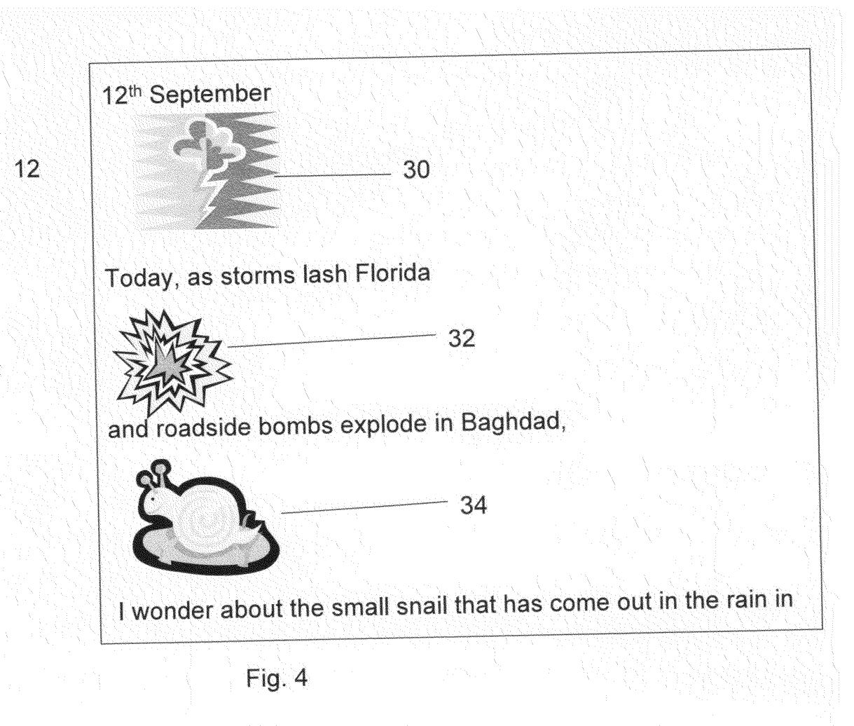

Reference is now made to FIG. 4 which shows the three suggestions of FIG. 1 as they may be inserted into the blog text 12 of FIG. 1. A first image 30, retrieved by understanding the word “storm” is inserted in association with the word storm. A second image 32, which may have been retrieved through a semantic understanding of either the term “bomb” or “explode” is located in association with those terms and a final image 34 is located in association with the term “snail”.

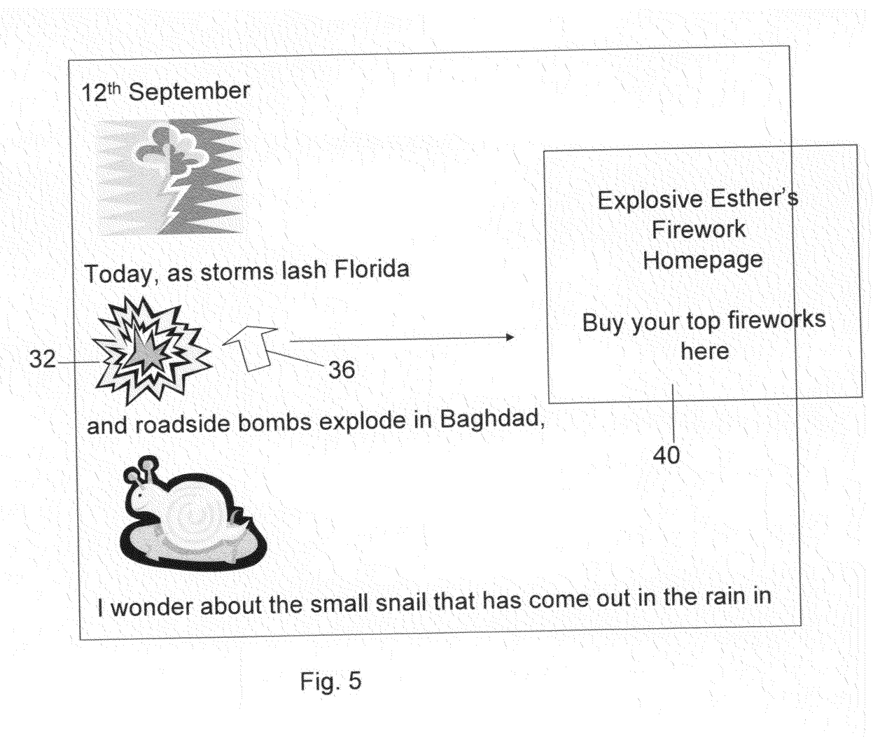

Reference is now made to FIG. 5, which illustrates the digital rights management features of the present invention. A user's cursor 36 hovers over image 32, causing a pop up label 40 to display a slogan. Clicking by the user on either the pop-up or the image itself leads to a commercial web site associated with the slogan. The owner of the commercial website thus receives advertising exposure and consequently pays for the content.

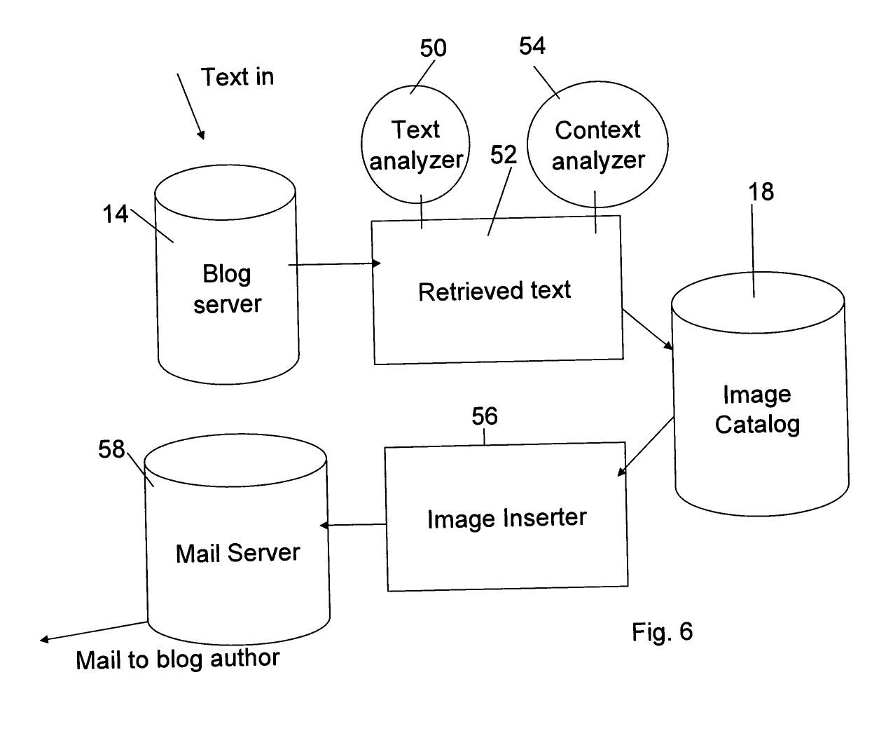

Reference is now made to FIG. 6, which is a simplified block diagram of a system for analyzing newly inserted blog text and providing appropriate suggestions to the blog author.

In FIG. 6, text is entered to blog server 14 as explained above and is retrieved for analysis. A text analyzer 50 may analyze the retrieved text 52, by looking for key words. Alternatively or additionally there may be provided a context analyzer 54 which carries out a semantic analysis of the retrieved text 52 in order to provide a contextual understanding of the material. The context analyzer may for example use a semantic understanding of the sentence to sort between candidate keywords to find out which are important and which not. For example, take the sentence, “the key to the situation is to find the driver” the text analyzer would identify the nouns key, situation, and driver. The context analyzer may understand that the term “key” is used metaphorically, that the term “situation” is non-focal and that the term “driver” is the focus of the sentence.

The identified key term is then used to search the image catalog 18 to retrieve suggestions as explained. Image inserter 56 then inserts the suggestions into an email which is forwarded via mail server 58 to the blog author.

It will be appreciated that the image catalog is only exemplary and databases may be provided of any kind of media that could enhance a blog.

In the event that large numbers of suggestions are found, the different suggestions may be ranked. Then the suggestions actually provided to the author may be limited to a maximum number of the highest ranking suggestions. Depending on the database, reliable ranking may however not be easy and so the system may instead arbitrarily limit the suggestions sent to a predetermined number. In a third embodiment a web author sets his own preferences as to the number of suggestions he wishes to obtain. As well as results of the textual analysis, user profile information such as the blogger's geographical location, gender, and type of audience can be used, as can the the post date, to provide data that will help to stream relevant media content.

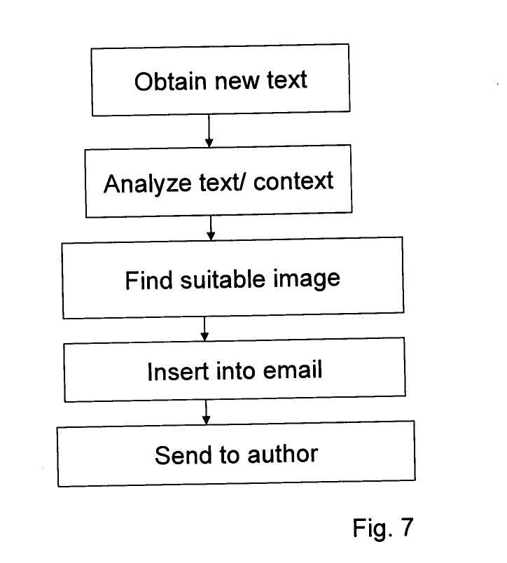

Reference is now made to FIG. 7 which is a simplified flow chart illustrating the process of providing a blog author with content to match newly inserted text. The system firstly obtains the new text. The text is analyzed for key words and/or semantics. A suitable image or any other kind of media items is found based on the text analysis, is inserted into an email and sent to the author as a suggestion for insertion into the blog.

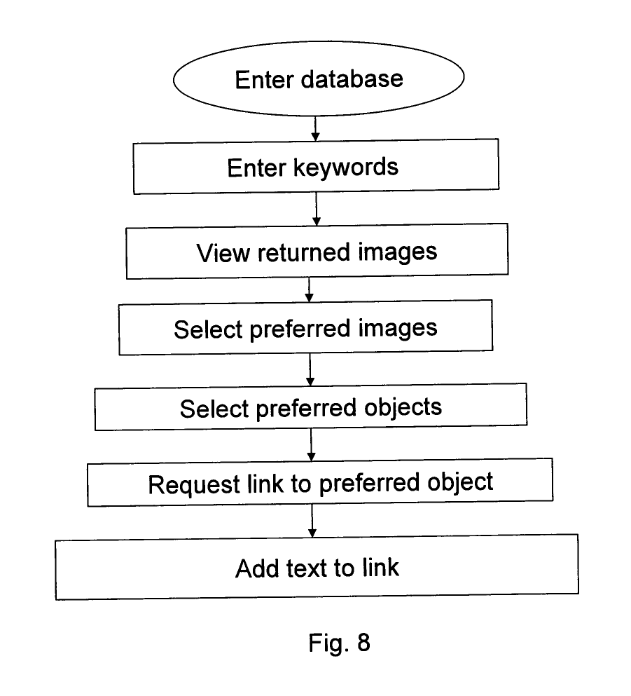

Reference is now made to FIG. 8, which is a simplified diagram illustrating a process in which images in a database can be made available for use to the public via selection by advertisers. An advertiser may enter a database of images or other media items and search using keywords for images which are related to his advertising campaign. The returned images are viewed and preferred images may be selected. Optionally the advertiser may select objects within the image. For example a seller of furniture may select an item of furniture to link to rather than selecting the entire image. The advertiser then adds a link to his website to the image. Text may be added for the link and associated popup.

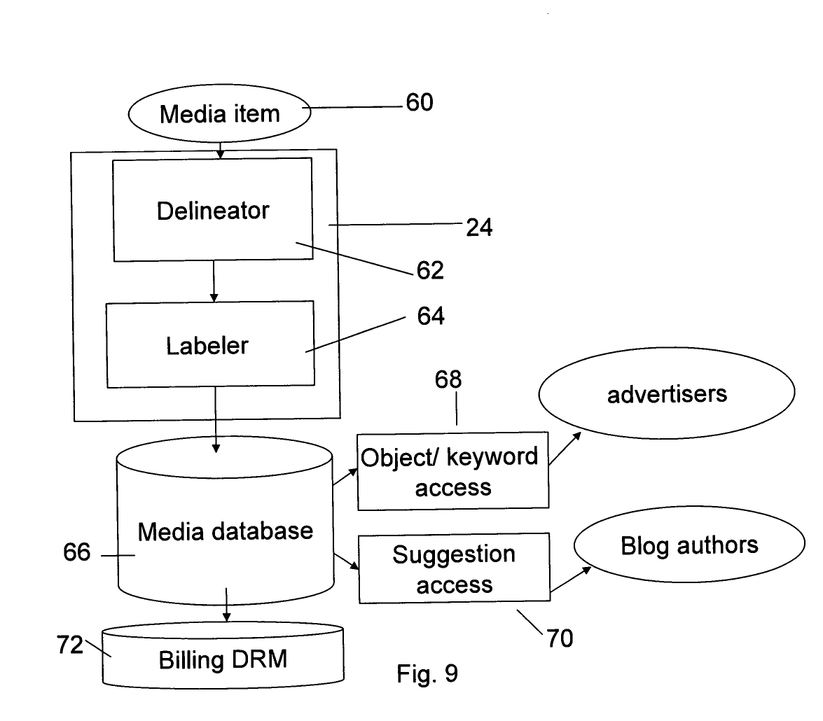

Reference is now made to FIG. 9, which is a simplified diagram illustrating apparatus for allowing digital rights managed images to be made available to advertisers and blog authors. A media item 60 is selected, either as a whole or for a part or object from within the media item. If a part of the image is selected, then the part is selected via delineator 62, which is capable of defining a region within the image that includes the desired object. The image or object is provided with a label via labeler linker tool 64 and placed in media database 66 for subsequent selection by an advertiser.

The labels are used as keywords to allow the media database to be searched by advertisers. Advertisers typically obtain access via keywords and keyword access tool 68 to allow them to select images which are of interest to their advertising campaigns. Then they insert links to their own sites.

The blog authors are not typically given keyword access to choose their own images and one of the reasons is that there may be some images which have not been selected by advertisers. The blog authors instead access the database through suggestions sent to them by mail as explained above, through suggestion access tool 70.

As an alternative, blog authors may be given keyword search access to the database, but the blogger's search is preferably modified to include only items which are already covered by advertisers.

A DRM server 72 manages the billing process and ensures that advertising revenues are passed from the advertiser to the rights holder and anyone else who may have rights to payment. The DRM server may charge a flat rate for a given image, or it may charge per use by a blog author or it may charge per click by a reader, as seems suitable to the service provider.

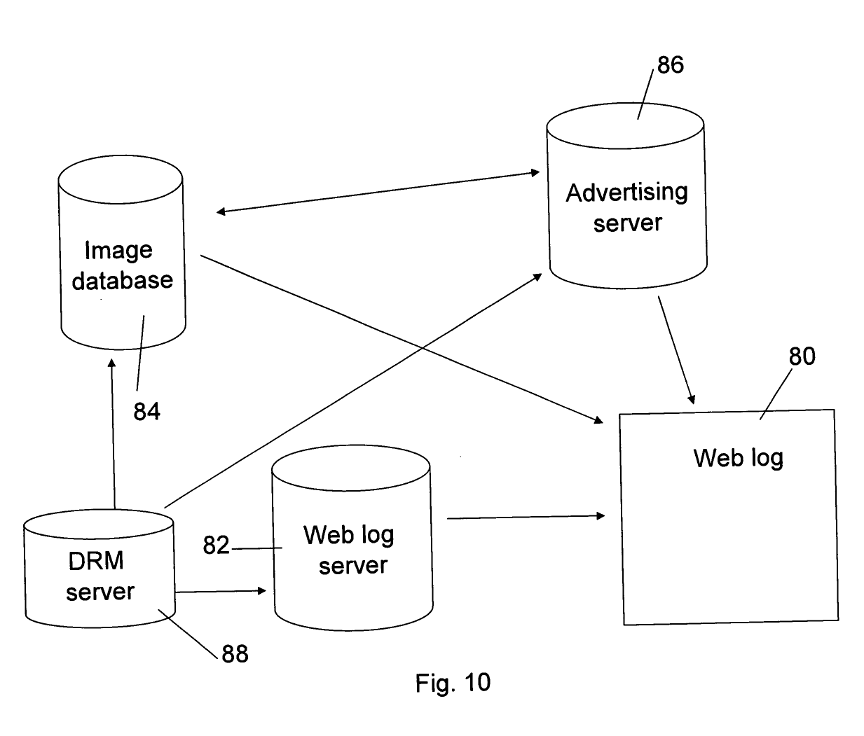

Reference is now made to FIG. 10, which is a simplified diagram illustrating a configuration of servers to support digital rights management of images on a blog or weblog. The blog 80 is accessible to users via web log server 82 and includes text as well as one or more images or other media items for which digital rights management is required. The image is pasted into the log from an email as explained above. The image originates from image database 84 which is equivalent to image catalog 18 discussed above. The image includes a link to advertising server 86 and allows a reader of the blog to reach the advertising site. A DRM billing 88 server ensures that payment reaches the rights holder from the advertiser.

If a reader of the blog now sees the image and wishes to adopt it for his own blog, then the present embodiments preferably allow such viral distribution. The blog reader is able to copy and paste the URL and use it directly and the DRM system continues to stream advertisement revenues to the content owners. Thus the spontaneity of Web 2.0 is maintained and web users are able to see something and use it on the spot, without stealing anything and without the need to go to any specialized locations and search for the content required.

It is expected that during the life of this patent many relevant devices and systems will be developed and the scope of the terms herein, particularly of the terms Web 2.0, Blog, and Text and Syntax Analysis, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Content provision apparatus for suggesting media content from a media database to augment new textual content, the apparatus comprising:
a text retrieval unit configured for retrieving new textual content over a network;
a text analysis unit associated with the text retrieval unit, configured for analyzing the retrieved textual content;
a search unit configured for using the analyzing of the retrieved textual content to search the media database to find media content suitable for said new textual content; and
a dispatch unit configured for dispatching to an author of said text retrieval unit a suggestion for augmenting said new textual content, said suggestion comprising said suitable media content.

2. Content provision apparatus according to claim 1, wherein said search unit is further configured to make use of user profile data to improve said searching of said media database.

3. Content provision apparatus according to claim 2, wherein said search unit is further configured to make use of audience profile data to improve said searching of said media database.

4. Content provision apparatus according to claim 1, wherein said text retrieval unit comprises a syndication feed.

5. Content provision apparatus according to claim 1, wherein said text retrieval unit comprises a web crawler.

6. Content provision apparatus according to claim 1, wherein said text retrieval unit comprises a networked connection to a server being a site on which said new textual content is published.

7. Content provision apparatus according to claim 1, wherein said text analysis unit comprises a keyword search unit for searching said retrieved text for keywords useful for searching said database.

8. Content provision apparatus according to claim 1, wherein said text analysis unit comprises a semantic analysis unit for semantically understanding said retrieved text.

9. Content provision apparatus according to claim 1, wherein said media database comprises media items associated with advertisement sites such that upon selection of said media items by an end user a payment action is triggered.

10. Content provision apparatus according to claim 9, further comprising a digital rights management server configured to manage said payment action to ensure that a right holder of said media item is compensated for use thereof.

11. Content provision apparatus according to claim 1, wherein said dispatch unit is configured to package said suggestion as an email, said email being configured to allow automatic pasting of said media item into said textual content.

12. Content provision apparatus according to claim 1, wherein said dispatch unit is configured to package said suggestion for sending over a direct link to a server on which said new textual content is being published.

13. Content provision apparatus according to claim 1, wherein said dispatch unit is configured to package said suggestion for sending over a syndication feed to a server on which said new textual content is being published.

14. Content provision apparatus according to claim 11, wherein said media content comprises an association with an advertising site and said email is configured to include said association with said automatic pasting.

15. Content provision apparatus according to claim 1, wherein said media content comprises an association with an advertising site, said association being transferable if said media content is copied from said textual content into other textual content.

16. Content provision method for suggesting media content from a media database to augment new textual content, the method comprising:
retrieving new textual content over a network;
analyzing the retrieved textual content;
using the analyzing of the retrieved textual content to search the media database to find media content suitable for said new textual content; and
dispatching to an author of said text retrieval unit a suggestion for augmenting said new textual content, said suggestion comprising said suitable media content.

17. Content provision method according to claim 16, wherein said text retrieval comprises using a syndication feed.

18. Content provision method according to claim 16, wherein said text retrieval comprises using a web crawler.

19. Content provision method according to claim 16, wherein said text analysis comprises searching said retrieved text for keywords useful for searching said database.

20. Content provision method according to claim 16, wherein said text analysis comprises making a semantic analysis for semantically understanding said retrieved text.

21. Content provision method according to claim 16, wherein said media database comprises media items associated with advertisement sites such that upon selection of said media items by an end user a payment action is triggered.

22. Content provision method according to claim 21, further comprising managing said payment action to ensure that a right holder of said media item is compensated for use thereof.

23. Content provision method according to claim 16, wherein said dispatching comprises packaging said suggestion as an email, said email being configured to allow automatic pasting of said media item into said textual content.

24. Content provision method according to claim 23, wherein said media content comprises an association with an advertising site and said email is configured to include said association with said automatic pasting.
